(19) United States
(12) Patent Application Publication
(10) Pub. No.: US 2003/0093812 A1
(43) Pub. Date: May 15, 2003

(54) System and method for delivering data to an information appliance using the ISO07816

(75) Inventors: Matthew S. Chang, San Diego, CA (US); Aditya Krishnan, San Diego, CA (US); Andrew M. Proehl, San Francisco, CA (US); David K.L. Yang, San Jose, CA (US); Frederick J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: Intellectual Property Department, Sony Electronics Inc., 123 Tice Boulevard - MD T1-1, Woodcliff Lake, NJ, 07677, US

(73) Assignee: Sony Corporation

(21) Appl. No.: 10/010,590

(22) Filed: Nov. 9, 2001

(51) Int. Cl. H04N 7/16; H04N 7/18; H04N 7/173

(52) U.S. Cl. 725/133; 725/81; 725/6; 725/141; 725/134

(57) ABSTRACT

The present invention includes a system for enabling a user to download information displayed on a display screen of a television receiver. The system includes a device coupled to said television receiver to access information to be displayed on the display screen and a portable data device adapted to download the information from the device. The device includes a set-top box and the portable data device may be a smart card which may include an integrated circuit (IC) chip having information stored therein. The set-top box includes a back-channel for outputting information and the portable data device is coupled to the device by way of a smart card reader. The portable data device includes a display, a processor, a memory, navigation buttons and a remind button. The portable data device may communicate to the device using the ISO7816 Protocol, USB Protocol, a Serial Parallel Interface, Sony Memory Stick Protocol, etc.

### BACKGROUND OF THE INVENTION

The present invention relates generally to an information system and method and, more particularly, to such system and method for enabling a user to download information displayed on a display screen of a television receiver to a portable device.

Today, a customer may view information displayed on a television screen. While viewing such information, if a user sees information he or she wishes to take with them, the user must write down the information.

Some devices found in the home have network communication capability, e.g. Personal Computers (PCs) equipped with phone or cable modems, and now even appliances i.e. smart refrigerators or smart stoves, are expected to be connected to the network in a few years. But there are many devices without a network connection. Some devices typically need a more capable input means, such as a PC, to edit data that eventually gets “synced” or downloaded to the appliance, e.g. Palm Pilot. Set Top Boxes (STBs) currently contain powerful CPUs internally, e.g. 300 MIPs or more. Yet they are under-utilized in connecting to other non-TV or non-VCR type of devices. Also, STBs have a smart card slot which may interface with other electronic devices. Manufacturers are currently looking at ways to enhance the existing relationship with content devices with add-on goods and services to the STB. The STB is a gateway into the home. The STB may be used by the Head-end (HE) to display screens of data, options, and menus, as well as to interact with devices which a plugged into the STB, e.g. portable data viewer—used for TV schedules, personal calendar and reminder, games, etc.

### OBJECTS AND SUMMARY OF THE INVENTION

It is an object of the present invention to provide a system and method in which a user may download displayed on a television screen to a portable device.

More specifically, it is an object of the present invention to provide a system and method as aforesaid in which the user downloads or uploads information displayed on a television screen by using a portable data device to read the information.

An aspect of the present invention is to provide a system for enabling a user to download information displayed on a display screen of a television receiver. The system includes a device coupled to said television receiver to access information to be displayed on the display screen and a portable data device adapted to download the information from the device. The device includes a set-top box and the portable data device may be a smart card which may include an integrated circuit (IC) chip having information stored therein. The set-top box includes a back-channel for outputting information and the portable data device is coupled to the device by way of a smart card reader. The portable data device includes a display, a processor, a memory, navigation buttons and a remind button. The portable data device may communicate to the device using the ISO7816 Protocol, Universal Serial Bus (USB), a Serial Parallel Interface, Sony Memory Stick Protocol, etc.

The above and other objects, features and advantages according to the present invention will be apparent from the following detailed description of the illustrated embodiments when read in conjunction with the accompanying drawings in which corresponding components are identified by the same reference numerals.

### BRIEF DESCRIPTION OF THE DRAWINGS

FIG. 1 is a system block diagram of a system using a set-top box;

FIG. 2 is a functional block diagram of a digital set-top box suitable for use with the present invention;

FIG. 3 is a diagram of a system according to an embodiment of the present invention;

FIG. 4 is a diagram of a smart card according to an embodiment of the present invention;

FIG. 5 is a diagram of an introductory screen according to an embodiment of the present invention; and

FIG. 6 is a diagram of a screen according to an embodiment of the present invention.

### DETAILED DESCRIPTION OF PREFERRED EMBODIMENTS

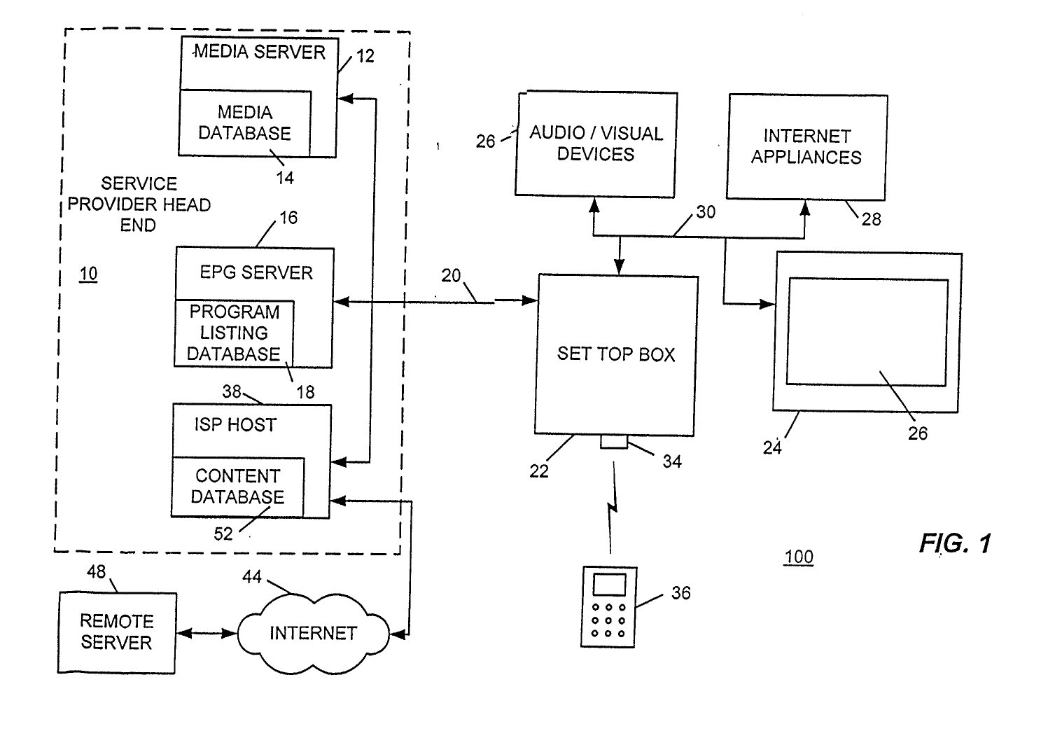

The preferred embodiments of the present invention will be described with reference to the accompanying drawings. Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bi-directional communication over a transmission medium 20 in the case of a cable STB 22. In other embodiments, bi-directional communication can be effected using asymmetrical communication techniques possibly using dual communication media—one for the uplink and one for the downlink. In any event, the STB 22 can have its own Universal Resource Locator (URL) assigned thereto to provide for addressability by the head end and users of the Internet.

The media server 12 and EPG server 16 are coupled by transmission medium 20 to a set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc . . . The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc . . . Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc . . . In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

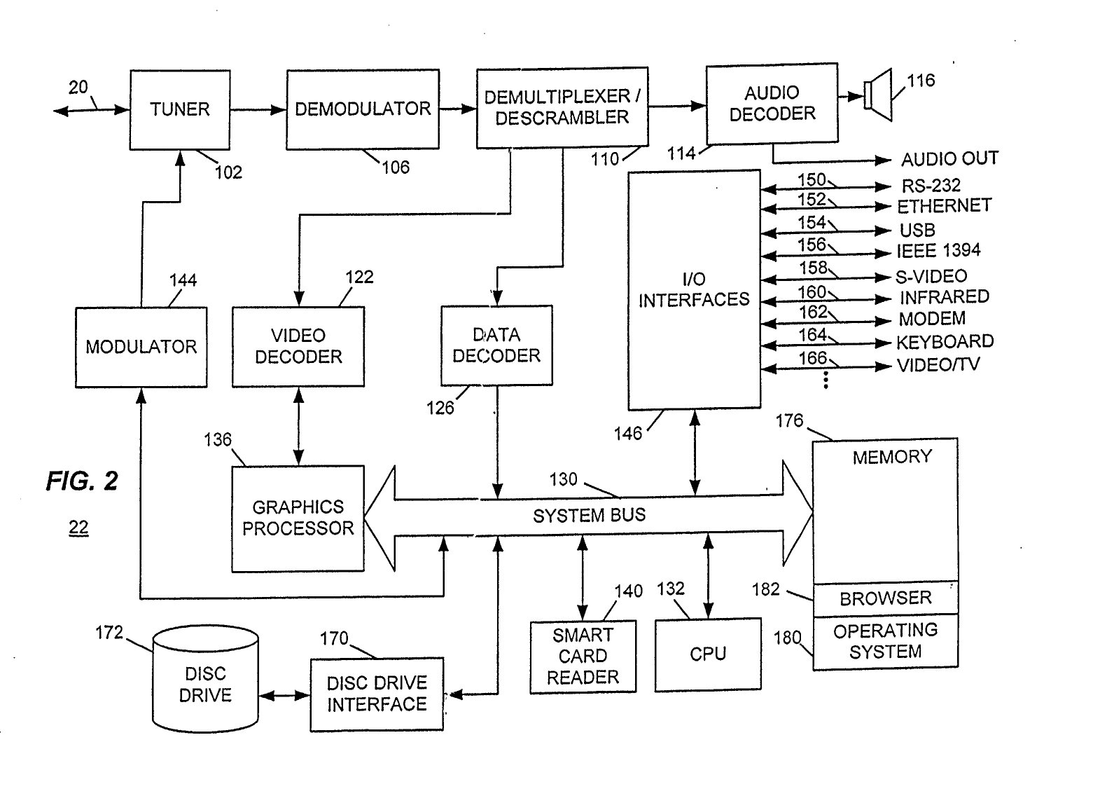

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band (0013) tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc . . .

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, video output 166 can provide composite video formatted as NTSC (National Television System Committee) video. In some embodiments, the video output 166 can be provided by a direct connection to the graphics processor 136 or the demultiplexer descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired. STB 22 may include a disc drive interface 170 and disc drive mass storage 172 for user storage of content and data as well as providing storage of programs operating on CPU 132. STB 22 may also, include floppy disc drives, CD ROM drives, CD R/W drives, DVD drives, etc . . . CPU 132, in order to operate as a computer, is coupled through the system bus 130 to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all include at the lowest layer various hardware interface layers. Next is an operating system layer as previously described. The software architectures of modem STBs have generally evolved to include a next layer referred to as “middleware”. Such middleware permits applications to run on multiple platforms with little regard for the actual operating system in place. Middleware standards are still evolving at this writing, but are commonly based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

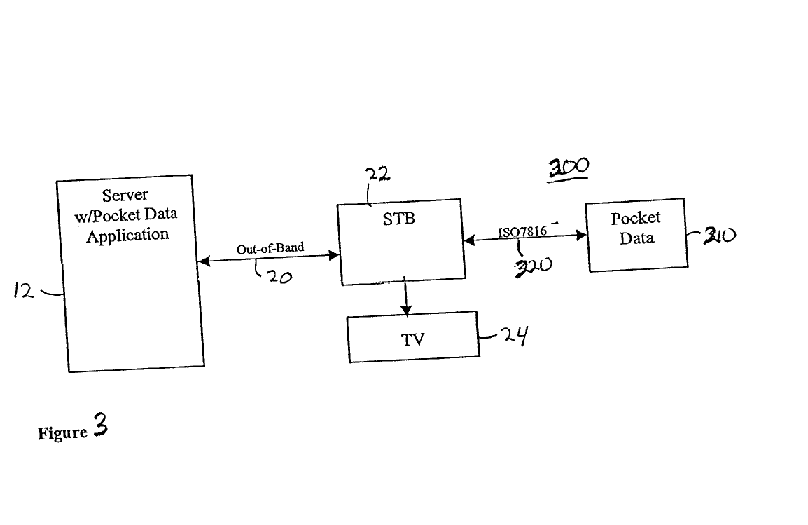

FIG. 3 illustrates a system 200. As shown therein, such system may include television 24, STB 22, a media server 12, a transmission medium 20 and a portable data device 200. The portable data device 200 is adapted to fit into the smart card reader 140 of the STB 22. The portable data device 200 exchanges information with the STB 22 by way of an ISO7816 interface 220. The STB 22 may be coupled to transmission medium 20 which, in turn, may be coupled to service provider 10 so as to receive television programming therefrom, in a manner as previously described. The STB 22 may also be coupled to the television 24 by way of a cable or interface such as interface 30 and/or output 166 so as to provide received television programming thereto for display on display 26.

Additionally, the STB 22 may be adapted to receive information from the portable data device 200, such as by way of the ISO7816 interface. The information received and transmitted from the portable device 200 may be processed by CPU 132 (FIG. 2). Such processing may include formatting and packetizing of the information data in a predetermined manner. The processed information may be supplied to a respective destination by way of a out-of-band or back channel transmission through transmission medium 20. The back channel may be through the modem 162 (FIG. 2) coupled to a telephone line (such as a plain old telephone service (POTS) line), a cable modem coupled to a cable modem, a DSL modem coupled to a DSL connection, an integrated services digital network (ISDN) line, an Ethernet connection to a network, a wireless connection to a network, and so forth. The destination may be the head end 10, a server 12, an ISP host 38, another STB 22 and so forth. The television 24, STB 22, and smart card reader 140 may be separate units or, alternatively, two or more of them may be combined into a single unit. For example, the television 24, STB 22, and the smart card reader 140 may be arranged in a single unit. As another example, the television 24 and STB 22 may be arranged in a single unit and the smart card reader 140 may be arranged in another separate unit.

The STB 22 may act as a transcoder. When working in this manner, the STB 22 performs a transcoding function. The STB 22 takes IP data from the Head End 10 and translates that data into ISO7816 commands. These commands are then sent to the portable data device 200. Operating in the other direction, the STB 22 accepts data from the portable data device 200 via ISO7816 commands, and places the data in an IP packet for delivery to the Head End 10. An application runs at the head end 10 with the STB 22 only performing a transcoding function. A new application may be downloaded to a portable data device 200 from the Head end 10. The head end 10 can detect when a portable data device 200 is inserted into the smart card slot 140 and cause the appropriate information to be generated and downloaded, e.g. downloading a Web Page or other data.

The STB 22 may also operate with the head end 10 as a data source. When operating in this manner, the STB 22 is enabled to interface with the portable data device 200 through the smart card reader 140. An interface application may be downloaded to the STB 22. Then, the STB 22 can access the head end 10 for files to download on user request to the portable data device 200. Alternatively, the STB 22 can process data that has been broadcast to all STBs 22 on a given network. For example, the STB 22 can process Service Information (SI) required by the STB 22 to access subscription and Instant Pay per View (IPPV) programming and format it for the portable data device 200.

The smart card reader 140 is an ISO7816 smart card interface located on the front panel of the STB22. The smart card reader is an interface that can be clocked at various rates. At the present time, the maximum clock rate is limited by the C-Cube 9311 chip which limits the clock rate to 113.68 Kilobits per second. The smart card reader may use an ISO7816 interface or a Universal Serial Bus (USB) Protocol, or a Serial Parallel Interface (SPI) or a proprietary system such as Sony's Memory Stick Interface and Protocol. It must be understood that the physical interface, e.g. Smart Card, SPI, or Memory Stick Interface, could be used with Universal Serial Bus (USB) protocol. In such a case, for example with a Smart Card, the serial transfer would be megabits per second instead of kilabits per second. The Smart Card would have a USB Controller built in.

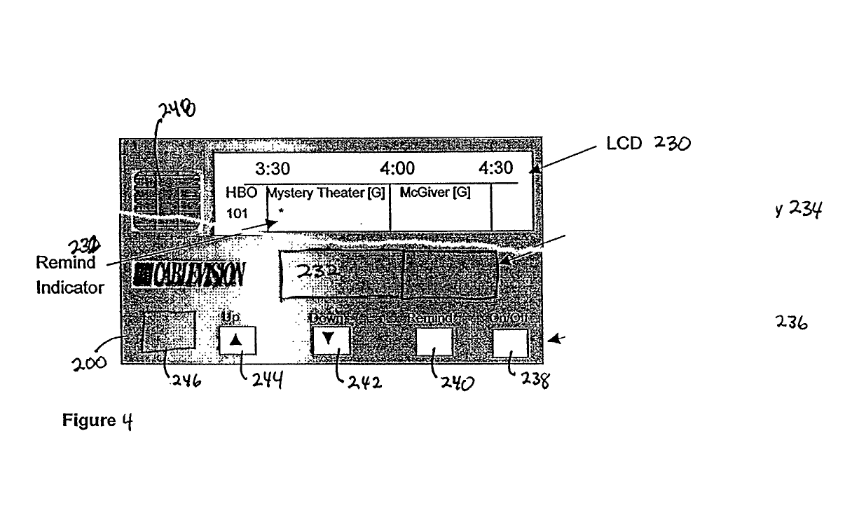

As shown in FIG. 4, the portable data device 200 may be an active type smart card. The portable data device 200 contains contacts a LCD display 230, a rechargeable battery 234, memory 246 and contacts 248. The user may interact with the portable data device 200 through keyboard buttons 236. These may be an on/off switch 238, a remind button 240, a down button 242 and an up button 244. Data may be transferred to the portable data device 200 through the contacts 248 and stored in the memory 246. The information stored in the portable data device 200 may be displayed on the LCD display 230.

There are many types of smart cards. First there are Straight Memory Cards. These cards just store data and have no data processing capabilities. These cards are the lowest cost per bit for user memory. They should be regarded as floppy disks of varying sizes without the lock mechanism. These cards cannot identify themselves to the reader, so your host system has to know what type of card is being inserted into a reader. Second, there are Protected/Segmented Memory Cards. These cards have built-in logic to control the access to the memory of the card. Sometimes referred to as Intelligent Memory cards these devices can be set to write protect some or the entire memory array. Some of these cards can be configured to restrict access to both reading and writing. This is usually done through a password or system key. Segmented memory cards can be divided into logical sections for planned multi-functionality. There are also CPU Multifunction Cards. These cards have on-card dynamic data processing capabilities. Multifunction smart cars allocate card memory into independent sections assigned to a specific function or application. These cards have a microprocessor or micro-controller chip that manages the memory allocation and file access

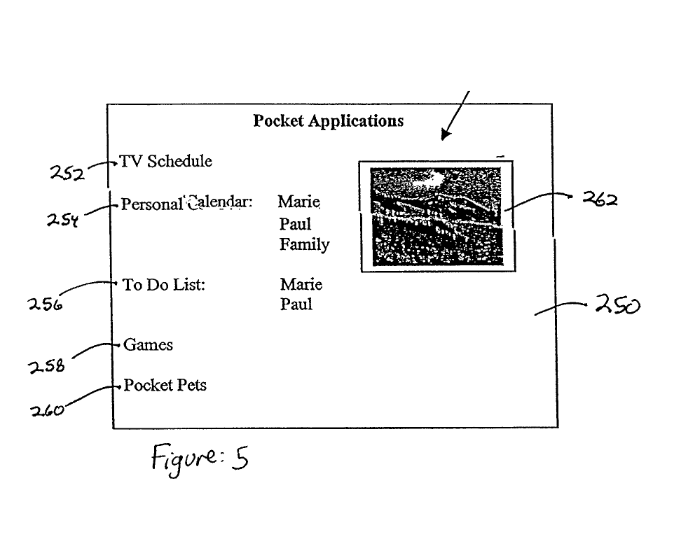

As shown in FIG. 5, in operation, the STB would display the introduction screen 250 on the television 24. The introduction screen 250 gives the user many options to show and then download to the portable data device 200. The options include, but are not limited to Television Schedule 252, Personal Calendars 254 for each member of the family, To Do Lists 256 for each member of the family, games 258 and Pocket Pets 260. The introduction screen also includes a Television Window 262 to show the chosen television channel while the user is viewing the introduction screen 250. The user then chooses an application, such as Television Schedule. Any number of applications may be supplied by way of the transmission medium 20 to the STB 22 whereupon the signals may be processed and supplied to the television 24 by way of the STB 22. This uses a combination of STB 22 and Head end 10 applications. This may be used for all types of downloads such as schedule, calendar, notes and game data. There is typically no further interaction after the download is made.

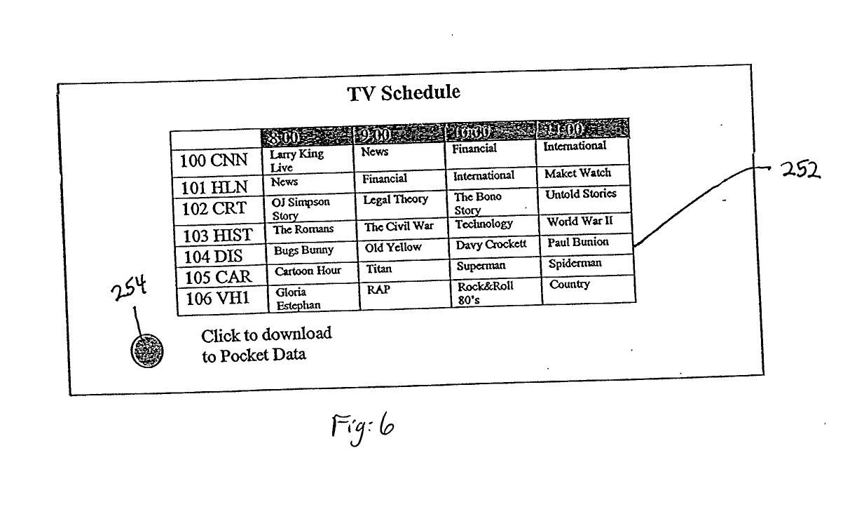

As shown in FIG. 6, a television schedule is displayed on the television 24. Upon viewing the television schedule, the user may click the download icon 254 to download the television schedule to a portable data device 200 through the smart card reader 140 of the STB 22. The received information is processed in a predetermined manner by the processor 232 (FIG. 4) so that it may be manipulated and displayed on the LCD display 230. The user may view TV Program Listings by scrolling using the up 244 and down 242 buttons and may press the remind 240 button to have the portable data device 200 remind the viewer when certain television programs are starting.

Furthermore, although in describing the present invention the portable data device 200 was described as being smart card, the present invention is not so limited. That is, other types of electronic gadget cards and credit card readers may be utilized. For example, the device may be a smart card such as a so-called SIM IC type card, a contactless integrated circuit (IC) type card having a contactless-type integrated circuit (IC) chip, an adaptor and so forth.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

What is claimed is:

1. A system for enabling a user to download information displayed on a display screen of a television receiver, said system comprising:
a device coupled to said television receiver to access information to be displayed on said display screen; and
a portable data device adapted to download said information from the device.

2. A system as in claim 1, wherein the device includes a set-top box.

3. A system as in claim 1, wherein said portable data device is a smart card.

4. A system as in claim 1, wherein said portable data device is a PDA.

5. A system as in claim 1, wherein said portable data device is a digital wallet.

6. A system as in claim 3, wherein said smart card includes an integrated circuit (IC) chip having information stored therein.

7. A system as in claim 1, wherein the device includes a back-channel for outputting information.

8. A system as in claim 1, wherein the portable data device is coupled to the device by way of a smart card reader/writer.

9. A system as in claim 1, wherein the portable data device includes a transmitter/receiver which transmits the read information in a wireless manner to the device.

10. A system as in claim 1, wherein the portable data device includes a display.

11. A system as in claim 1, wherein the portable data device includes a processor.

12. A system as in claim 1, wherein the portable data device includes a memory.

13. A system as in claim 1, wherein the portable data device includes navigation buttons.

14. A system as in claim 1, wherein the portable data device includes a remind button.

15. A system as in claim 8, wherein the portable data device is communicates to the device using the ISO7816 Protocol.

16. A system as in claim 8, wherein the portable data device is communicates to the device using the Universal Serial Bus Protocol.

17. A system as in claim 8, wherein the portable data device is communicates to the device using the Serial Parallel Interface.

18. A system as in claim 8, wherein the portable data device is communicates to the device using the Sony Memory Stick Protocol.

19. A system for enabling a user to download information displayed on a display screen of a television receiver, said system comprising:
a set-top box having a back-channel and adapted to be coupled to first and second signal lines so as to receive television signals by way of the first signal line representative of a number of items offered for sale and provide the received television signals to said television receiver so as to enable the information to be displayed on said display screen; and
a portable data device adapted to download said information from the set-top box.

20. A method for enabling a user to download information displayed on a display screen of a television receiver, the method comprising the steps of:
receiving television signals at a receiving device representative of information and providing the received television signals to a television receiver so as to enable the information to be displayed on said display screen; and
downloading the information to a portable data device.

21. A method as in claim 20, wherein the receiving device includes a set-top box.

22. A method as in claim 20, wherein said portable data device is a smart card.

23. A method as in claim 22, wherein said card includes an integrated circuit (IC) chip having information stored therein.

24. A method as in claim 20, further comprising the step of outputting information from the portable display device.

25. A method as in claim 20, wherein the read information is forwarded to said receiving device by way of a data line.

26. A method as in claim 20, wherein the portable data device is coupled to the device by way of a smart card reader.

27. A system as in claim 20, wherein the portable data device includes a transmitter which transmits the read information in a wireless manner to the device.

28. A system as in claim 20, wherein the portable data device includes a display.

29. A system as in claim 20, wherein the portable data device includes a processor.

30. A system as in claim 20, wherein the portable data device includes a memory.

31. A system as in claim 20, wherein the portable data device includes navigation buttons.

32. A system as in claim 20, wherein the portable data device includes a remind button.

33. A system as in claim 25, wherein the portable data device is communicates to the device using the ISO7816 Protocol.

34. A system as in claim 25, wherein the portable data device is communicates to the device using the Universal Serial Bus Protocol.

35. A system as in claim 25, wherein the portable data device is communicates to the device using a Serial Parallel Interface.

36. A system as in claim 25, wherein the portable data device is communicates to the device using the Sony Memory Stick Protocol.
